(19) United States
(12) Patent Application Publication
(10) Pub. No.: US 2006/0133491 A1
(43) Pub. Date: Jun. 22, 2006

(54) Video codec

(75) Inventors: Sung Ho Lee, Seoul (KR); Young Hool Hwang, Seoul (KR); Woon Ki Park, Suwon-si (KR)

Correspondence Address: JONATHAN Y. KANG, ESQ.;LEE, HONG, DEGERMAN, KANG & SCHMADEKA, 801 S. Figueroa Street, 14th Floor, Los Angeles, CA, 90017, US

(73) Assignee: LG Electronics Inc.

(21) Appl. No.: 11/315,767

(22) Filed: Dec. 21, 2005

(30) Foreign Application Priority Data
Dec. 22, 2004 (KR) 10-2004-0110565

(51) Int. Cl. H04N 7/12; H04N 11/04; H04B 1/66; H04N 11/02

(52) U.S. Cl. 375/240.12

(57) ABSTRACT

A video codec is provided. A coded first frame image is decoded and stored. A second frame is coded by referring to the decoded first frame image. The second frame image is not used as a reference image. For this purpose, the second frame image does not pass through a decoding module/decoding process for creating a reference image.

This application claims the benefit of the Korean Patent Application Nos. 10-2004-0110565, filed on Dec. 22, 2004, which is hereby incorporated by reference herein in their entirety.

### BACKGROUND OF THE INVENTION

1. Field of the Invention

The present invention relates to a video codec.

2. Description of the Related Art

Most of moving picture compression standards such as CODEC based on MPEG or H.26x employ a compression encoding scheme based on a motion estimation & compensation and transformation. Such an encoding based on the motion estimation & compensation has to encode a motion vector information of each block, and a compression efficiency greatly changes according to how to encode the motion vector.

According to a general process of encoding moving picture, a digital video signal is converted based on an orthogonal transform coding such as a discrete cosine transform (DCT), and a transform coefficient is quantized and a variable length coding (VLC) is performed on the quantized transform coefficient. Meanwhile, the quantized DCT coefficient is inverse-quantized and inverse-DCTed and then a decoded image is stored in a memory. A motion vector (MV) is calculated using the decoded image stored in the memory and a next frame image. The motion vector is VLCed. The VLCed motion vector and the encoded image information construct a bit stream.

A general coding method of a moving picture can be divided into a single image compression (intra coding, I frame encoding) and a motion estimation compression (inter coding, P frame encoding). The case of the moving picture widely uses a successive motion estimation compression scheme (inter coding) and periodically uses a single compression scheme (intra coding).

FIG. 1 is a block diagram of a related art apparatus of encoding a moving picture. The encoding apparatus of FIG. 1 is an I frame encoder.

Referring to FIG. 1, the related art I frame encoder includes an orthogonal transform coder 101 for performing an orthogonal transform coding on an input digital video signal, a quantizer 102 for quantizing a transform coefficient of the orthogonal transform coder 101, a run length coder 103 for performing a run length coding (RLC) on the quantized value outputted from the quantizer 102, a variable length coder 104 for performing a variable length coding (VLC) on an output of the run length coder 103, a multiplexer 105 for constructing a bit stream using an output of the variable length coder 104, a buffer 106 for storing an output of the multiplexer 105, a coding controller 107 for controlling the quantization and the construction of the bit stream, an inverse quantizer 108 for inversely quantizing an output of the quantizer 102, an orthogonal transform decoder 109 for performing an orthogonal transform decoding on an output of the inverse quantizer 108, and a frame memory 110 for storing a decoded video signal outputted from the orthogonal transform decoder 109.

The orthogonal transform coder 101 performs an orthogonal transform coding, such as a DCT, on the digital video signal inputted in pixel block unit (e.g., 8×8). The quantizer 102 performs a quantization on the orthogonal-transform-coded data (e.g., DCT coefficient), and performs a compression by expressing the coded data with several representative values. The run-length coder 103 performs a run length coding (RLC) on the output of the quantizer 102. The variable length coder 104 performs a variable length coding (VLC) on the output of the run length coder 103 and inputs the VLCed data to the multiplexer 105.

The multiplexer 105 multiplexes the coded digital data and stores it in the buffer 106. The buffer 106 is used to construct the output bit stream. Also, a state of the buffer 106 is feed back to the coding controller 107 so as to properly control a bit rate according to a moving picture transmission environment. The coding controller 107 controls the bit rate by adjusting a quantization step.

Meanwhile, the output of the quantizer 102 is inversely quantized by the inverse quantizer 108. The inversely quantized data is decoded through the orthogonal transform decoder 109. The decoded video signal is stored in the frame memory 110. The decoded video signal stored in the frame memory 110 is referred to video information of a previous frame.

FIG. 2 is a block diagram of a related art apparatus of encoding a digital moving picture. The encoding apparatus of FIG. 2 is a P frame compression encoder.

Referring to FIG. 2, the related art P frame encoder includes an orthogonal transform coder 201 for performing an orthogonal transform coding on an input digital video signal, a quantizer 202 for quantizing a transform coefficient of the orthogonal transform coder 201, a run length coder 203 for performing a run length coding (RLC) on the quantized value outputted from the quantizer 202, a variable length coder 204 for performing a variable length coding (VLC) on an output of the run length coder 203, a multiplexer 205 for constructing a bit stream using an output of the variable length coder 204, a buffer 206 for storing an output of the multiplexer 205, a coding controller 207 for controlling the quantization and the construction of the bit stream, an inverse quantizer 208 for inversely quantizing an output of the quantizer 202, an orthogonal transform decoder 209 for performing an orthogonal transform decoding on an output of the inverse quantizer 208, a frame memory 210 for storing a decoded video signal outputted from the orthogonal transform decoder 209, a motion compensator 211 for performing a motion compensation on the video signal stored in the frame memory 210, a motion estimator 212 for performing a motion estimation by referring to the video signal stored in the frame memory 210 and the input digital video signal, and a variable length coder 213 for performing a variable length coding (VLC) on a motion vector outputted from the motion estimator 212 and supplying the VLCed motion vector to the multiplexer 205.

The orthogonal transform coder 201 performs an orthogonal transform coding, such as a DCT, on the digital video signal inputted in pixel block unit (e.g., 8×8). The quantizer 202 performs a quantization on the orthogonal-transform-coded data (e.g., DCT coefficient), and performs a compression by expressing the coded data with several representative values. The run-length coder 203 performs a run length coding (RLC) on the output of the quantizer 202. The variable length coder 204 performs a variable length coding (VLC) on the output of the run length coder 203 and inputs the VLCed data to the multiplexer 205.

The multiplexer 205 multiplexes the coded digital data and stores it in the buffer 206. The buffer 206 is used to construct the output bit stream. Also, a state of the buffer 206 is feed back to the coding controller 207 so as to properly control a bit rate according to a moving picture transmission environment. The coding controller 207 controls the bit rate by adjusting a quantization step.

Meanwhile, the output of the quantizer 202 is inversely quantized by the inverse quantizer 208. The inversely quantized data is decoded through the orthogonal transform decoder 209. The decoded video signal is stored in the frame memory 210. The decoded video signal stored in the frame memory 210 is referred to video information of a previous frame.

The previous frame image stored in the frame memory 210 is motion-compensated by the motion compensator 211, and a difference signal between the motion-compensated video signal of the previous frame and the digital video signal of the current frame is provided to the orthogonal transform coder 201. Meanwhile, the motion estimator 212 calculates the motion vector (MV) for each macro block by using the digital video signal of the previous frame stored in the frame memory 210 and the digital video signal of the current frame. The variable length coder 213 receives the motion vector calculated by the motion estimator 212, removes a statistical overlap by performing a VLC on the motion vector, and provides it to the multiplexer 205.

The related art encoding apparatus includes both the encoding module and the decoding module. The encoded video signal is decoded, and the decoded video signal is stored in the frame memory. Then, the decoded video signal is used for the motion estimation in a next frame. Such a structure is very efficient in increasing the compression efficiency. However, the complexity of the P frame is greater than that of the I frame, thus increasing the entire encoding complexity.

A still picture compression technology such as JPEG uses a single image compression scheme, and MPEG 1, 2 and 4 uses a combination of a single image compression scheme and a motion estimation compression scheme. Compared with the motion estimation compression scheme, the single image compression scheme has a relatively simple structure. Therefore, a moving picture compression scheme in a low-grade hardware employs a Motion-JPEG that continuously uses I frame coding alone. The Motion-JPEG compression scheme using the single image compression scheme has a simple structure, thereby providing the convenient implementation and the efficiency of hardware resources. However, the Motion-JPEG image compression scheme has a lower compression efficiency than that of the motion estimation scheme. Therefore, there is a need for design of a model compromising the two schemes so as to overcome the above-described drawbacks.

Since the existing moving picture encoder includes the motion estimation and compensation, the P frame is more complex than the I frame. However, since the P frame has a higher compression efficiency, more than 90% of the data is coded using the P frame and the remaining data is coded using the I frame. In this case, hardware with good performance is required, thus increasing a cost. Also, hardware burden is imposed in mounting the apparatus on the mobile terminal. It acts as an obstruction to miniaturization.

Accordingly, there is a demand for a moving picture compression technology that can provide a compatibility with an existing MPEG based standard, reduce a complexity down to the Motion-JPEG, and maintain higher performance that that of the Motion-JPEG, even when its compression efficiency is lower than the MPEG series.

In mobile terminals such as mobile phone with moving picture recording/playing function, portable multimedia player, and PDA, complex hardware acts as an obstruction factor in miniaturization and lightweight. Despite, such a mobile terminal requires high level of moving picture recording and playing. Therefore, there is a demand for a moving picture compression encoding technology that can be efficiently used in various terminals with moving picture processing function, including the mobile terminal.

### SUMMARY OF THE INVENTION

Accordingly, the present invention is directed to an apparatus and method of encoding a moving picture that substantially obviate one or more problems due to limitations and disadvantages of the related art.

An object of the present invention is to provide an apparatus and method of encoding a moving picture, capable of reducing the encoding complexity.

Another object of the present invention is to provide an apparatus and method of encoding a moving picture, capable of reducing an overall coding complexity. By alternately repeating I frame and P frame, the motion estimation/compensation process of the P frame encoding can be eliminated. Based on this, a complex P frame structure can be simplified.

A further another object of the present invention is to provide a hybrid-type apparatus and method of encoding a moving picture, capable of providing a perfect compatibility with an existing standard technology. An existing MPEG based standard can be used in compressing the moving picture, the complexity can be reduced to a Motion-JPEG level, and the compression efficiency can be optimized by comprising the MPEG and Motion-JPEG.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus of encoding a moving picture in a video codec, the moving picture having a first frame image coded without referring to other frame images and a second frame image coded by referring to other frame images, the apparatus including: a first coder for coding the first frame image; a decoder for decoding the coded first frame image and storing the decoded first frame image; and a second coder for coding the second frame image by referring to the decoded first frame image, without decoding.

In another aspect of the present invention, there is provided a method of encoding a moving picture, the moving picture having a first frame image coded without referring to other frame images and a second frame image coded by referring to other frame images, the method comprising: coding the first frame image; decoding the coded first frame image and storing the decoded first frame image; and coding the second frame image by referring to the decoded first frame image, wherein a decoding for use the second frame image as a reference image is not performed on the coded second frame image.

In a further another aspect of the present invention, there is provided a method of encoding a moving picture, including: coding a first frame image, which does not refer to other frame image, with accompanying a decoding; and coding a second frame image, which refers to other frame image, by referring to the decoded first frame image without decoding.

The first frame image and the second frame image are alternately coded. The first frame image and the second frame image may be an I frame image and a P frame image, respectively. The I frame image and the P frame image can be alternately coded one by one in sequence.

Accordingly, the present invention can provide a compatibility with an existing moving picture encoder, reduce its complexity, and provide higher encoding performance than a low grade hardware. The present invention can be applied to high grade of mobile terminal and attribute to higher level of multimedia function than an existing high-quality moving picture recording and playing. That is, the present invention can provide a compatibility with an existing MPEG based standard, reduce a complexity down to the Motion-JPEG, and maintain higher performance that that of the Motion-JPEG, even when its compression efficiency is lower than the MPEG series. Consequently, the high-speed encoding performance can be secured even in a low-performance hardware environment, and a complex P frame structure can be simplified, thereby reducing an overall encoding complexity.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating an I frame process in an apparatus of encoding a moving picture;

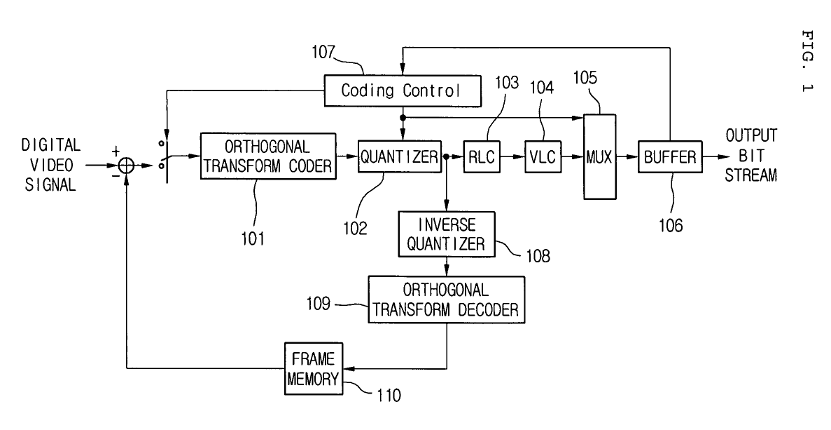

FIG. 2 is a block diagram illustrates a P frame process in an apparatus of encoding a moving picture;

FIG. 3 is a block diagram of an apparatus of encoding a moving picture according to a first embodiment of the present invention;

FIG. 4 is a block diagram of an apparatus of encoding a moving picture according to a second embodiment of the present invention; and

FIG. 5 is a flowchart illustrating a method of encoding a moving picture.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

An apparatus of encoding a moving picture according to the present invention can lower an entire encoding complexity by reducing difference of complexity between I frame video signal encoded without referring to other frame video signals and P frame video signal encoded while referring to other frame video signals. Since a motion estimation process is not required in the encoding process of the I frame, there is no problem in the entire performance when the decoding process of a just previous P frame is eliminated.

Therefore, the video codec according to the present invention accompanies a decoding process in the encoding of the I frame video signal and does to accompany a decoding process of the P frame video signal. Also, the decoding is performed only on the encoded I frame video signal, and the decoded I frame video signal is used as a reference image in the encoding of the P frame. A frame sequence to encode the I frame video signal and the P frame video signal alternately encodes the I frame and the P frame. For example, in the compression frame sequence such as IPP . . . PIPP . . . PIPP . . . , which is a general sequence of moving picture compression, the decoding module contained in the P frame and the motion estimation process are removed by periodically repeating IPIPIP . . .

In this embodiment, the I frame video signal is encoded, and the encoded I frame video signal is decoded. Then, it is stored as a reference image for motion estimation in encoding a next P frame video signal. The P frame video signal is encoded by referring to a previously decoded I frame video signal. In encoding the P frame video signal, a decoding process for using it as a reference image of a next frame is not performed. When a next I frame video signal is inputted, an encoding process is performed on the I frame video signal, and the encoded I frame video signal is stored as a reference image for encoding a next P frame video signal. By repeating these processes, a decoding module/decoding process in the encoding of the P frame video signal is eliminated.

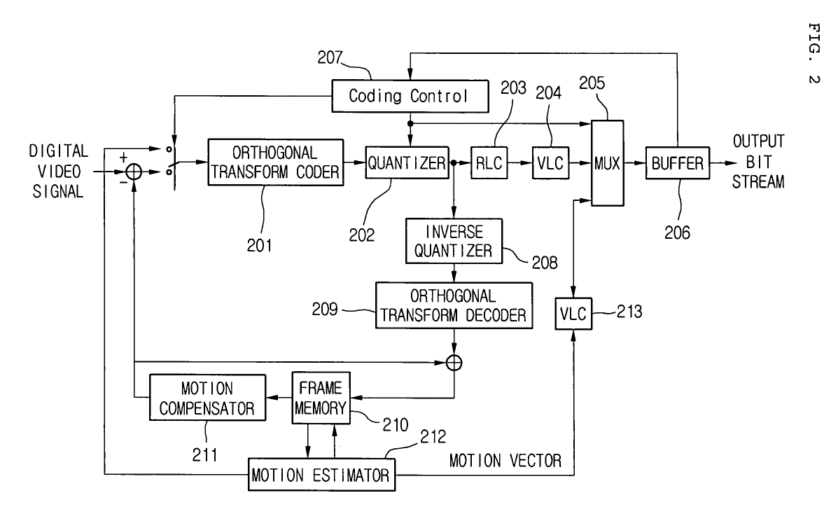

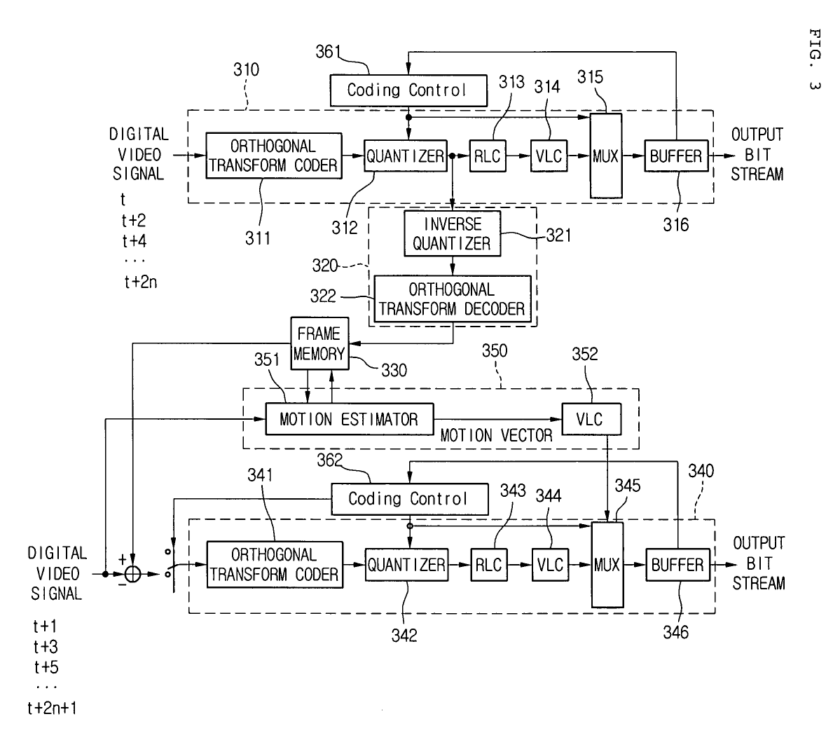

FIG. 3 is a block diagram of an apparatus of encoding a moving picture according to an embodiment of the present invention. According to the encoding apparatus of FIG. 3, the decoding block in the P frame encoding process of FIG. 2 is eliminated and thus the encoding complexity is reduced, thereby providing higher encoding speed than the related art.

Referring to FIG. 3, the encoding apparatus according to the present invention includes a first compression coder 310 for sequentially performing an orthogonal transform coding, quantization, RLC, VLC, and a construction of bit stream with respect to an input digital video signal in order for the I frame compression encoding, a first coding controller 361 for controlling a compression encoding of the first compression coder 310 such that I frame and P frame are alternately compressed and coded, a decoder 320 for performing an inverse quantization and orthogonal transform decoding with respect to the quantized output information of the first compression coder 310, a frame memory 330 for storing the video signal decoded by the decoder 320, a second compression coder 340 for sequentially performing an orthogonal transform coding, quantization, RLC, VLC, and a construction of bit stream with respect to a difference video signal between the input digital video signal and an output of the frame memory 330 in order for the P frame compression encoding, a motion estimation coder 350 for performing a motion estimation using the output of the frame memory 330 and the P frame input digital video signal and outputting a motion vector, performing a VLC, and a second coding controller 362 for controlling a compression coding of the second compression coder 340 such that I frame and P frame are alternately compressed and coded.

The first compression coder 310 includes an orthogonal transform coder 311 for performing an orthogonal transform coding on an input digital video signal, a quantizer 312 for quantizing a transform coefficient of the orthogonal transform coder 311, a run length coder 313 for performing a run length coding (RLC) on the quantized value outputted from the quantizer 312, a variable length coder 314 for performing a variable length coding (VLC) on an output of the run length coder 313, a multiplexer 315 for constructing a bit stream using an output of the variable length coder 314, and a buffer 316 for storing an output data of the multiplexer 315.

The decoder 320 includes an inverse quantizer 321 for inversely quantizing an output of the quantizer 312, and an orthogonal transform decoder 322 for performing an orthogonal transform decoding on an output of the inverse quantizer 321.

The second compression coder 340 includes an orthogonal transform coder 341 for performing an orthogonal transform coding on the input digital video signal, a quantizer 342 for quantizing a transform coefficient of the orthogonal transform coder 341, a run length coder 343 for performing a run length coding (RLC) on th quantized value outputted from the quantizer 342, a variable length coder 344 for performing a variable length coding (VLC) on an output of the run length coder 343, a multiplexer 345 for constructing a bit stream using an output of the variable length coder 344, and a buffer 346 for storing an output of the multiplexer 345.

The motion estimation coder 350 includes a motion estimator 351 for performing a motion estimation by referring to a video signal stored in the frame memory 330 and the input digital video signal, and a variable length coder 352 for performing a variable length coding (VLC) on the motion vector outputted from the motion estimator 351 and providing the VLCed motion vector to the multiplexer 345.

According to the present invention, as illustrated in FIG. 3, in the compression frame sequence such as IPP . . . PIPP . . . PIPP . . . , which is a general sequence of moving picture compression, the decoding module contained in the P frame is removed by periodically repeating IPIPIP . . . That is, by eliminating the decoding block in the P frame coding process of FIG. 2, the encoding complexity is reduced to thereby increase the encoding speed.

An operation of the encoding apparatus according to the present invention will be described below with reference to FIG. 3.

Referring to FIG. 3, the first compression coder 310 performs an I frame compression coding on digital video signals t, t+1, t+2, t+4, . . . , t+2n. First, the orthogonal transform coder 311 performs an orthogonal transform coding, such as a DCT, on the digital video signal inputted in an 8×8 pixel block unit. The quantizer 312 performs a quantization on the orthogonal-transform-coded data (e.g., DCT coefficient), and performs a compression by expressing the coded data with several representative values. The run-length coder 313 performs a run length coding (RLC) on the output of the quantizer 312. The variable length coder 314 performs a variable length coding (VLC) on the output of the run length coder 313 and inputs the VLCed data to the multiplexer 315. The multiplexer 315 multiplexes the coded digital data and stores it in the buffer 316.

The buffer 316 is used to construct the output bit stream. Also, a state of the buffer 316 is feed back to the coding controller 361 so as to properly control a bit rate according to a moving picture transmission environment. The coding controller 361 controls the bit rate by adjusting a quantization step.

Meanwhile, the I frame digital video signal coded by the first compression coder 310 is decoded for the P frame encoding, and is then stored in the frame memory 330. That is, the output of the quantizer 312 is inversely quantized by the inverse quantizer 321. The inversely quantized data is decoded through the orthogonal transform decoder 322. The decoded video signal is stored in the frame memory 330. The decoded video signal stored in the frame memory 330 is used as a previous frame video information for calculating a motion vector in the encoding of the P frame.

The second compression coder 340 performs a P frame compression coding on digital video signals t+1, t+3, t+5, . . . , t+2n+1.

First, the orthogonal transform coder 341 performs an orthogonal transform coding, such as a DCT, on the digital video signal inputted in an 8×8 pixel block unit. The quantizer 342 performs a quantization on the orthogonal-transform-coded data (e.g., DCT coefficient), and performs a compression by expressing the coded data with several representative values. The run-length coder 343 performs a run length coding (RLC) on the output of the quantizer 342. The variable length coder 344 performs a variable length coding (VLC) on the output of the run length coder 343 and inputs the VLCed data to the multiplexer 345. The multiplexer 345 multiplexes the coded digital data and stores it in the buffer 346.

The buffer 346 is used to construct the output bit stream. Also, a state of the buffer 346 is feed back to the coding controller 362 so as to properly control a bit rate according to a moving picture transmission environment. The coding controller 362 controls the bit rate by adjusting a quantization step.

A difference signal between the decoded video signal of the previous I frame stored in the frame memory 330 and the digital video signal of the current frame is calculated and provided to the orthogonal transform coder 341. Meanwhile, the motion estimation coder 350 calculates the motion vector by referring to the digital video signal of the current frame together, and performs a variable length coding (VLC) on the motion vector, and then provides the VLCed motion vector to the multiplexer 345.

The motion estimator 351 calculates the motion vector (MV) for each macro block by using the decoded digital video signal of the previous I frame stored in the frame memory 330 and the digital video signal of the current P frame. The variable length coder 352 receives the motion vector calculated by the motion estimator 351, removes a statistical overlap by performing a VLC on the motion vector, and provides it to the multiplexer 345. In this manner, it is used when constructing the bit stream of the P frame compression coding data. In the encoding of the P frame video signal, the P frame video signal need not be provided as a reference image for motion estimation of the next frame (the I frame in this embodiment). Therefore, the decoding is not performed. Also, the motion compensation is not performed.

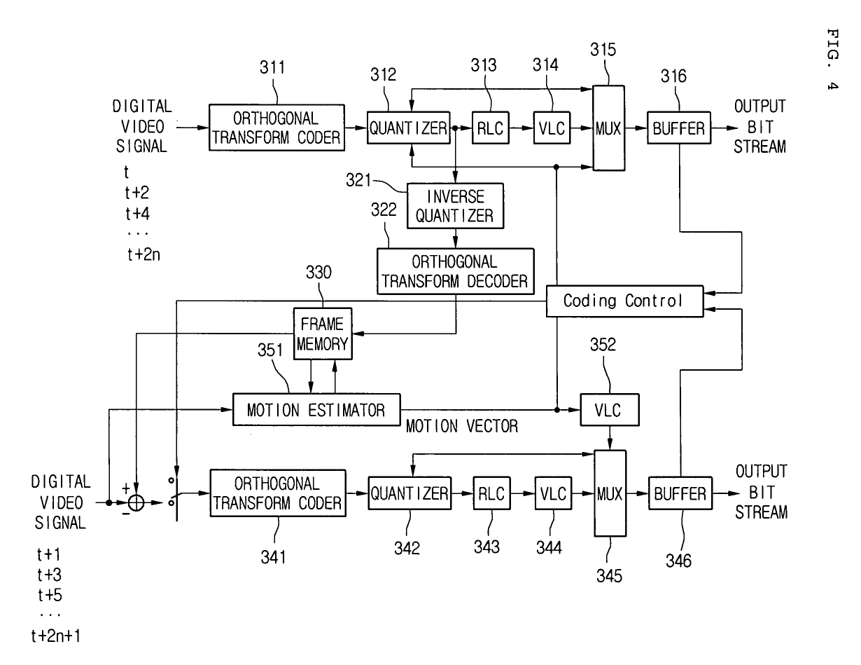

FIG. 4 is a block diagram of an apparatus of encoding a moving picture according to another embodiment of the present invention. Unlike the embodiment of FIG. 3, one coding controller 360 controls the I frame compression coding and the P frame compression coding. That is, according to the encoding apparatus of FIG. 3, the I frame compression coding and the P frame compression coding are separately controlled by the respective controller. On the contrary, according to the encoding apparatus of FIG. 4, the single controller 360 controls the I frame compression coding and the P frame compression coding. The organic/functional connection relationship of the other components is identical to that of FIG. 3. In FIGS. 3 and 4, the same reference numerals are used to refer to the same elements.

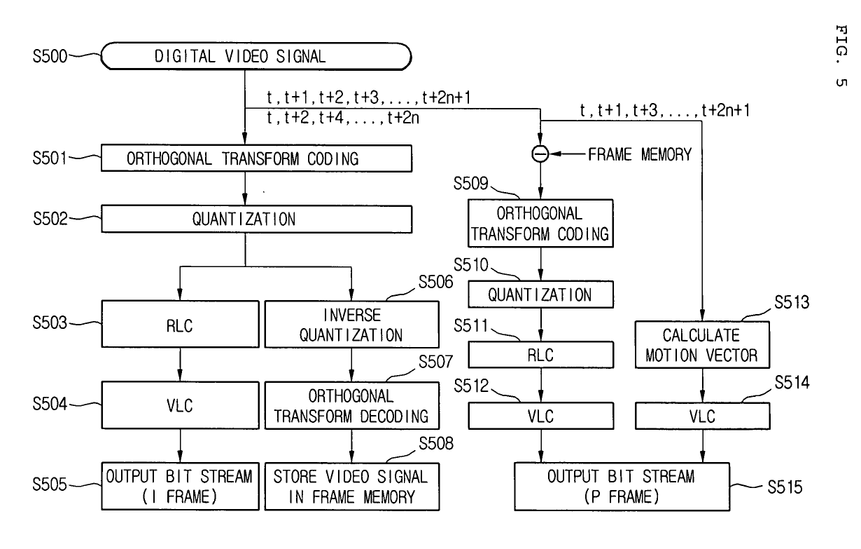

FIG. 5 is a flowchart illustrating a method of encoding a moving picture according to an embodiment of the present invention. Referring to FIG. 5, input digital video signals are discriminated so that they are alternately coded in the order of IPIPIP . . . (S500). Regarding the I frame, the orthogonal transform coding is performed on the input digital video signals t, t+2, t+4, . . . , t+2n (S501). The orthogonal-transform-coded data are quantized (S502). Then, the run length coding (RLC) is performed on the quantized data (S503) and the variable length coding (VLC) is performed on the quantized data (S504), and bit stream with respect to the I frame is outputted (S505). Also, the quantized data are inversely quantized (S506) and decoded into the previous I frame video signals through the orthogonal transform decoding (S507). Then, the decoded data are stored in the frame memory (S508). The previous I frame video signals stored in the frame memory is used in the P frame encoding, which will be described later.

Regarding the P frame, the orthogonal transform coding is performed on the input digital video signals t+1, t+3, t+5, . . . , t+2n+1 (S509). The orthogonal-transform-coded data are quantized (S510). Then, the run length coding (RLC) is performed on the quantized data (S511) and the variable length coding (VLC) is performed on the RLCed data (S512). Then, bit stream with respect to the P frame is outputted (S515). At this time, the motion vector calculating operation and the VLC operation are also performed on the input digital video signals. Considering the VLCed motion vector information together, the bit stream with respect to the P frame is constructed and outputted. That is, the motion vector is calculated using the previous I frame video signals stored in the frame memory and the input digital video signals of the current frame (S513). Then, the variable length coding (VLC) is performed on the calculated motion vector information (S514) and thus the bit stream with respect to the P frame is constructed and outputted. Accordingly, the decoding process of the encoded video signals with respect to the P frame is not performed and the motion compensation process is also not performed.

It will be apparent to those skilled in the art that various modifications and variations can be made in the present invention. Thus, it is intended that the present invention covers the modifications and variations of this invention provided they come within the scope of the appended claims and their equivalent.

What is claimed is:

1. A method of encoding a moving picture, the moving picture having a first frame image coded without referring to other frame images and a second frame image coded by referring to other frame images, the method comprising:
coding the first frame image;
decoding the coded first frame image and storing the decoded first frame image; and
coding the second frame image by referring to the decoded first frame image,
wherein a decoding for use the second frame image as a reference image is not performed on the coded second frame image.

2. The method according to claim 1, wherein as the decoding of the second frame image is not performed, the second frame image is not used as a reference image of another second frame image.

3. The method according to claim 1, wherein as the decoding of the second frame image is not performed, a motion compensation is not performed on the second frame image.

4. The method according to claim 1, wherein a coding based on motion information is performed on the second frame image by referring to the decoded first frame image.

5. The method according to claim 1, wherein the first frame image and the second frame image are an I frame and a P frame, respectively.

6. The method according to claim 1, wherein the first frame image and the second frame image are alternately coded.

7. The method according to claim 1, wherein the first frame image and the second frame image are alternately coded one by one.

8. The method according to claim 1, wherein the first frame image and the second frame image are an I frame and a P frame, respectively, and the order of the coding is a repetition of the I frame and the P frame (IPIP).

9. A method of encoding a moving picture, comprising:
coding a first frame image, which does not refer to other frame image, with accompanying a decoding; and
coding a second frame image, which refers to other frame image, by referring to the decoded first frame image without decoding.

10. The method according to claim 9, wherein as the decoding of the second frame image is not performed, the second frame image is not used as a reference image of another second frame image.

11. The method according to claim 9, wherein as the decoding of the second frame image is not performed, a motion compensation is not performed on the second frame image.

12. The method according to claim 9, wherein a coding based on motion information is performed on the second frame image by referring to the decoded first frame image.

13. The method according to claim 9, wherein the first frame image and the second frame image are an I frame and a P frame, respectively.

14. The method according to claim 9, wherein the first frame image and the second frame image are alternately coded.

15. The method according to claim 9, wherein the first frame image and the second frame image are alternately coded one by one.

16. The method according to claim 9, wherein the first frame image and the second frame image are an I frame and a P frame, respectively, and the order of the coding is a repetition of the I frame and the P frame (IPIP).

17. An apparatus of encoding a moving picture in a video codec, the moving picture having a first frame image coded without referring to other frame images and a second frame image coded by referring to other frame images, the apparatus comprising:
a first coder for coding the first frame image;
a decoder for decoding the coded first frame image and storing the decoded first frame image; and
a second coder for coding the second frame image by referring to the decoded first frame image, without decoding.

18. The apparatus according to claim 17, wherein the first frame image and the second frame image are alternately coded.

19. The apparatus according to claim 17, wherein the first frame image and the second frame image are an I frame and a P frame, respectively.

20. The apparatus according to claim 17, wherein the first frame image and the second frame image are an I frame and a P frame, respectively, and the order of the coding is a repetition of the I frame and the P frame (IPIP).
